(19) United States
(12) Patent Application Publication
(10) Pub. No.: US 2025/0197279 A1
(43) Pub. Date: Jun. 19, 2025

(54) COASTAL KARST CEMENT-BASED EXPANDING GROUTING MATERIAL AND PREPARATION METHOD THEREFOR

(71) Applicant: SHANDONG UNIVERSITY, Jinan, Shandong (CN)

(72) Inventors: Shucai LI, Jinan (CN); Zhaofeng LI, Jinan (CN); Jian ZHANG, Jinan (CN); Chunjin LIN, Jinan (CN)

(73) Assignee: SHANDONG UNIVERSITY, Jinan, Shandong (CN)

(21) Appl. No.: 18/834,024

(22) PCT Filed: Jun. 21, 2023
(86) PCT No.: PCT/CN2023/101711

§ 371 Date: Jul. 29, 2024

(30) Foreign Application Priority Data
Jun. 23, 2022 (CN) 202210718346.X

(51) Int. Cl. C04B 7/34; C04B 7/28; C04B 12/04; C04B 18/06; C04B 22/04; C04B 22/12; C04B 24/18; C04B 24/26; C04B 24/38; C04B 40/00; C04B 103/30; C04B 111/70; C09K 8/487

(52) U.S. Cl. CPC C04B 7/34; C04B 7/28; C04B 12/04; C04B 18/067; C04B 22/04; C04B 22/124; C04B 24/18; C04B 24/2641; C04B 24/2652; C04B 24/2664; C04B 24/38; C04B 40/0032; C09K 8/487; C04B 2103/302; C04B 2111/70

(57) ABSTRACT

A coastal karst cement-based expanding grouting material and a preparation method therefor. The material comprises components A and B; the component A comprises a cementing material with volcanic ash characteristics, water and an expanding agent of 0.01-6.0%; and the component B comprises the following in weight percentages: 0.2-1.3% of a water-soluble vegetable gum, 0.5-2.0% of polyacrylamide, 0.01-2.0% of a polyacrylic acid derivative salt, 0.02-1.5% of a complexing agent, 0.05-1.5% of polyhydroxy polysaccharides, 2-70% of water glass and 42.3-90.3% of water. The coastal karst cement-based expanding grouting material has good stability in flowing water, and can fill and reinforce unfavorable geological structures in coastal karst areas, specifically filling fissures and karst caves, plugging water passing channels and the like. Besides, the expansion of the cement-based expanding material is adjustable and can be adjusted and controlled according to the actual filling working condition of the karst caves.

The present invention claims the priority of Chinese Patent Application No. 202210718346.X, entitled “Coastal Karst Cement-Based Expanding Grouting Material and Preparation Method therefor” filed on Jun. 23, 2022 to Chinese patent office, the disclosure of which is incorporated by reference herein in its entirety in the present invention.

### TECHNICAL FIELD

The present invention belongs to the technical field of grouting materials and particularly relates to a coastal karst cement-based expanding grouting material and a preparation method therefor.

### BACKGROUND

Information for disclosing this background section is only for the purpose of increasing understanding of the general background of the present invention, and is not necessarily regarded as an acknowledgement or any form of suggestion that the information constitutes the prior art already known to those of ordinary skill in the art.

The karst area of China is about 3 million square kilometers, accounting for about one third of the territorial area of China. The ground collapse caused by the characteristics of the karst is often encountered in vigorous development of the construction of foundation of high-rise buildings or underground engineering in the coastal areas, various unfavorable geology such as karst caves, karst cavities, water-containing fissures and the like are disclosed, and therefore the requirements on the performances of grouting materials are severe. Aiming at the geological characteristics of “high erosion, multiple karst caves and abundant flowing water” of the coastal karst, it is urgently needed to invent a strongly pertinent cement-based expanding grouting material with erosion resistance by complexing, filling by expanding and dispersion resistance by cementing in the construction of underground engineering so as to ensures the treatment of unfavorable geological disasters in a special hydrogeological environment of the coastal karst.

### SUMMARY

Aiming at the existing problems in the prior art, the present invention provides a coastal karst cement-based expanding grouting material and a preparation method therefor. The coastal karst cement-based expanding grouting material of the present invention has good stability under the condition of flowing water, and can fill and reinforce unfavorable geological structures in coastal karst areas, specifically filling fissures and karst caves, plugging water passing channels and the like. Besides, the expansion of the cement-based expanding material is adjustable and can be adjusted and controlled according to the actual filling working condition of the karst caves.

To achieve the above technical effects, the present application provides the following technical solutions:

A first aspect of the present invention provides a coastal karst cement-based expanding grouting material. The expanding grouting material is composed of components A and B; the component A comprises a cementing material with volcanic ash characteristics, water and an expanding agent of 0.01-6.0%, and the water-to-cementing material ratio is (0.5-0.9):1; and the component B comprises the following components in weight percentages: 0.2-1.3% of a water-soluble vegetable gum, 0.5-2.0% of polyacrylamide, 0.01-2.0% of a polyacrylic acid derivative salt, 0.02-1.5% of a complexing agent, 0.05-1.5% of polyhydroxy polysaccharides, 2-70% of water glass and 42.3-90.3% of water. The water-to-cementing material ratio is preferably 0.6:1.

Further, the cementing material with volcanic ash characteristics is selected from one or more of silicate cement, granulated blast furnace slag, fly ash, kiln dust, silica fume, quicklime and gypsum.

The granulated blast furnace slag with better grain composition is preferred and the mixing amount thereof is 2-20% by mass of the cement-based solid material, most preferably 5-15%.

Further, the silicate cement comprises one or more of 42.5, 42.5R, 52.5 and 52.5R common silicate cement.

Further, the expanding agent comprises one or more of mixing materials of a polyacrylate derivative, sodium dodecyl sulfonate, sodium dodecyl sulfate, aluminum dodecyl sulfate, α-alkenyl sodium sulfonate and aluminum powder.

Further, the water-soluble vegetable gum comprises one or more of guar gum, pectin, locust bean gum, carrageenan, xanthomonas polysaccharide, carob bean gum, gelatin, low acyl gellan gum and high acyl gellan gum.

Further, the polyacrylamide and the polyacrylic acid derivative salt thereof comprise one or more of polyacrylamide, sodium polyacrylate and calcium polyacrylate.

Further, the complexing agent comprises one or more of polyaluminium chloride, polyferric chloride, polyaluminium silicate, polyferric silicate, sodium citrate and sodium hexametaphosphate.

Further, the polyhydroxy polysaccharides comprises one or two of polyethylene glycol-2000, sodium gluconate, sodium alginate and curdlan.

Further, the water glass comprises one or more of sodium silicate, potassium silicate, sodium aluminate, sodium fluoride and calcium formate.

Further, the expanding agent is prepared into a solution and from the following components in mass percentages: 0.01-0.05% of a polyacrylate derivative, 0.02-0.05% of sodium dodecyl sulfonate, 0.02-0.05% of sodium dodecyl sulfate, 0.02-0.05% of aluminum dodecyl sulfate, 0.03-1.5% of α-alkenyl sodium sulfonate and 0-0.6% of aluminum powder. Preferably, the expanding agent is prepared into a solution and from the following components in mass percentages: 0.01-0.04% of a polyacrylate derivative, 0.02-0.04% of sodium dodecyl sulfonate, 0.02-0.03% of sodium dodecyl sulfate, 0.02-0.025% of aluminum dodecyl sulfate, 0.05-1.2% of α-alkenyl sodium sulfonate and 0-0.4% of aluminum powder. The expanding agent solution is mixed with a solution A.

Further, the component B comprises the following components in percentages: 0.5-1.3% of the water-soluble vegetable gum, 0.3-1.3% of the polyacrylamide and an acrylic acid derivative salt thereof, 0.01-0.3% of the complexing agent, 0.05-1.2% of the polyhydroxy polysaccharides, 2-35% of the water glass and 55.3-91.3% of the water.

Further, the volume ratio of the component A to the component B is (0.5-5):1, preferably (1-4):1, further preferably (1-3):1, and most preferably 3:1.

Further, the component A further comprises an early strength agent or a water reducing agent. Preferably, the early strength agent accounts for 0.3-3.5% of the total mass of the cementing material in the component A. Preferably, the early strength agent comprises one or two of lithium chloride and sodium chlorate. The water reducing agent accounts for 0.4-2.4% of the total mass of the cementing material in the component A. Preferably, the water reducing agent comprises a lignosulfonate water reducing agent or a polycarboxylic acid water reducing agent.

On a second aspect, the present invention provides a method for preparing the coastal karst cement-based expanding material, comprising:
(1) preparation of component A: mixing the cementing material with volcanic ash characteristics with the water to prepare a slurry, preparing an expanding agent solution, and adding same into the slurry to prepare a slurry A; and
(2) preparation of component B: in weight percentages, dissolving the water-soluble vegetable gum, the polyacrylamide and an acrylic acid derivative salt thereof, the complexing agent and the polyhydroxy polysaccharides in the water, and then adding the water glass to prepare a slurry B for later use.

On a third aspect, the present invention provides a method for filling and plugging coastal karst flowing water using the coastal karst cement-based expanding grouting material, comprising:
S1: determining the respective proportions of the components A and B according to the content of ions in the flowing water, the size of a conduit karst cavity, the flow velocity of the flowing water, the water pressure and the distance between a drill hole and a flowing water channel;
S2: preparing the components A and B into the slurries A and B according to the respective proportions for later use; and
S3: performing grouting using the slurries A and B at the volume ratio of (0.5-5):1 by the means of two-slurry grouting. Preferably, the volume ratio of the slurries A and B is (1-4):1, further preferably (1-3):1, most preferably 3:1.

Further, in step S1, when the content of the ions in the flowing water (C(_{SO4}²⁻) is ≥0.8 g/L and C(Cl⁻) is ≥5.3 g/L) is high, the size of the karst cavity is greater than 1 m*1 m*1 m, and the flow velocity of the flowing water is greater than 0.5 mls, the water-to-cementing material ratio in the component A is lower than 0.9 and the mixing amount of each auxiliary material of the component B is increased; and when the content of the ions in the flowing water (C(_{SO4}²⁻) is ≤0.8 g/L and C(Cl⁻) is ≤5.3 g/L) is low, the size of the karst cavity is smaller than 0.5 m*0.5 m*0.5 m, and the flow velocity of the flowing water is smaller than 0.5 mls, the water-to-cementing material ratio in the component A is selected to be 1.0 and the mixing amount of auxiliary materials of the component B is decreased.

On a fourth aspect, the present invention provides use of the coastal karst cement-based expanding material in the fields of high-speed railways, expressways, urban railway system, large-scale hydraulic and hydroelectric engineering and deep mine construction.

The present invention has the following beneficial effects:

1. The coastal karst cement-based expanding grouting material has good stability under the condition of flowing water.

Under the velocity of the flowing water of 1.2 m/s, the retention of the slurry after initial solidification is 82-98% and therefore plugging of the flowing water at high flow velocity can be realized.

2. The coastal karst cement-based expanding grouting material of the present invention can fill and reinforce unfavorable geological structures in coastal karst areas, specifically filling fissures and karst caves, plugging water passing channels and the like. Besides, the expansion of the cement-based expanding material is adjustable and can be quantitatively adjusted and controlled according to the actual filling working condition of the karst caves within 2%-10%.

3. A concretion body of the coastal karst cement-based expanding grouting material of the present invention is reduced along with the increase of the volume of the expanded body. Under the slight expanding condition (<2%), the 1-d compressive strength of the concretion body is 0.2-1.5 MPa and the 3-d compressive strength is 0.5-4.0 MPa.

4. The flowing water anti-dispersion plugging material provided by the present invention is safe and nontoxic, and does not cause the problems of environmental pollution and the like.

### BRIEF DESCRIPTION OF THE DRAWINGS

The accompany drawings of the description constituting a part of the present application provide further understanding of the present application. The schematic examples of the present application and description thereof are intended to be illustrative of the present application and do not constitute an undue limitation of the present application.

FIG. 1 is a ternary bonding solid solution theoretical graph;

FIG. 2 shows the relationship between the mixing amount and the volume expansion rate of the present invention; and

FIG. 3 is a photograph of a real object of the cement-based expanding grouting material.

### DETAILED DESCRIPTION

It should be pointed out that the following detailed description is illustrative and is intended to provide further explanation of the present application. Unless otherwise defined, all technical and scientific terms used herein have the same meaning as commonly understood by one of ordinary skilled in the art to which the present application pertains.

Due to the special hydrogeological condition in karst areas, karst caves, karst cavities and subsidence areas are hidden in the stratum, and unfavorable geology are extremely easily encountered in the construction of underground engineering. In the grouting filling treatment process, due to the characteristics of grouting blindness, and wide range, large volume, fuzzy edge and the like of the unfavorable geologic structures, the waste of a grouting slurry is easily caused, such that the research and development of the grouting plugging material with slight expansibility are particularly important. On the basis of the complex hydrogeological characteristics of the karst areas and aiming at the filling treatment of the unfavorable geologic structures such as karst caves, karst cavities and the like disclosed in the construction process, the cement-based expanding material is prepared using two control technologies of physical expansion and chemical expansion. The present invention mainly relates to a foaming control technology and an erosive ionic bonding technology.

The foaming control technology:

Physical foaming: since molecules of the expanding agent such as sodium dodecyl sulfonate, sodium dodecyl sulfate and the like have hydrophilic groups and hydrophobic groups, compact and uniform foams can be formed after full stirring and mixing. The foams have good stability under the influence of amphiphilic groups in a cement slurry, are not easy to dissipate, and further achieve the effect of macroscopic volume expansion of the slurry.

Chemical foaming: in the expanding agent, aluminum powder and a hydration product calcium hydroxide (CH) are subjected to a redox reaction in an alkaline environment provided by the cement slurry to produce tiny hydrogen foams. The design objective of the volume expansion of the grouting material is achieved by controlling the specific gravity of the slurry and the mixing amount of reagents such as α-alkenyl sodium sulfonate and the like with foam-stabilizing and protecting functions.

The specific reaction equation is as follows:

C3S+H₂O═C—S—H+CH

2Al+6H₂O═2Al(OH)₃+3H₂↑(under weak alkaline condition)

C3S+H₂O═C—S—H+CH

2Al+6H₂O═2Al(OH)₃+3H₂↑ (1)

2Al(OH)₃+Ca(OH)₂ (CH)═Ca[Al(OH)₄]₂ (2)

Combining (1)+(2) to obtain

2Al+Ca(OH)₂ (CH)+6H₂O═Ca[Al(OH)₄]2+3H₂↑(under strong alkaline condition)

Coastal karst erosive ionic bonding technology:

Due to the unique geographical position of a limestone mine in a salt pan of a Hepu mining area and the unique coastal-inland binary system hydrological runoff replenishment and the like, a water burst point of a mine pit mainly uses two water burst modes of floor water burst and cliff wall water, and is distributed in a scattered manner and a cluster-shaped manner. The water accumulation of the mine pit is serious, the difficulty of burst water construction organization of the limestone mine is greatly increased, and therefore the service stability of a grouting curtain under the action of seawater erosion and tide is seriously researched.

A part of karst areas in China are influenced by special area positions and have the coastal-inland hydrological binary system characteristics, which provides a serious challenge for grouting construction operation in the areas, particularly for the anti-erosion property of a grouting material.

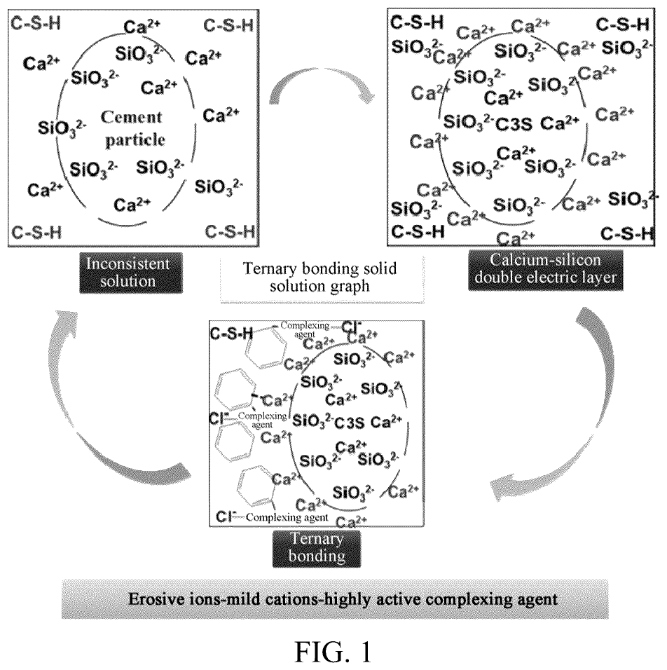

Aiming at objective factors such as coastal karst ion erosion and the like, a ternary bonding solid solution theory is innovatively provided. A high-performance complexing agent with unique hydrophilic functional groups is added, such that ternary bonding solid solution of erosive ions (Cl⁻+SO₄²⁻) in seawater-common cations (such as Ca²⁺, Na⁺ and the like)-complexing agent is performed in a concretion body of cement, and erosion damage of the erosive ions to the grouting material is reduced. Meanwhile, the hydrated calcium chlorate gel formed after the solid solution fills gaps of the concretion body to a certain extent, the compressive strength of the concretion body is enhanced, and the service stability of the concretion body of the grouting material is prolonged as shown in FIG. 1.

### Example 1

A coastal karst cement-based expanding grouting material was provided. The expanding grouting material was composed of components A and B; the component A comprised 42.5 silicate cement, water and an expanding agent of 1.725%, and the water-to-cementing material ratio was 0.6:1; and the component B comprised the following components in weight percentages: 0.2% of guar gum, 2.0% of polyacrylamide, 0.01% of calcium polyacrylate, 0.02% of sodium hexametaphosphate, 1.5% of polyethylene glycol-2000, 70% of sodium silicate and 26.27% of water.

The expanding agent was prepared into a solution and from the following components in mass percentages: 0.04% of a polyacrylate derivative, 0.04% of sodium dodecyl sulfonate, 0.02% of sodium dodecyl sulfate, 0.025% of aluminum dodecyl sulfate, 1.2% of α-alkenyl sodium sulfonate and 0.4% of aluminum powder.

A method for preparing the coastal karst cement-based cementing expanding material comprised:
(1) preparation of component A: the cementing material was mixed with the water to prepare a slurry and an expanding agent solution was prepared for later use; and
(2) preparation of component B: in weight percentages, the water-soluble vegetable gum, the polyacrylamide and an acrylic acid derivative salt thereof, the complexing agent and the polyhydroxy polysaccharides were dissolved in the water, and then the water glass was added to prepare a slurry B for later use.

A method for filling and plugging coastal karst flowing water using the coastal karst cement-based expanding grouting material comprised:
S1: the respective proportions of the components A and B were determined according to the content of ions in the flowing water, the size of a conduit karst cavity, the flow velocity of the flowing water, the water pressure and the distance between a drill hole and a flowing water channel; when the content of the ions in the flowing water (C(_{SO4}²⁻) was ≥0.8 g/L and C(Cl⁻) was ≥5.3 g/L) was high, the size of the karst cavity was greater than 1 m*1 m*1 m, and the flow velocity of the flowing water was greater than 0.5 mls, the water-to-cementing material ratio in the component A was lower than 0.9 and the mixing amount of each auxiliary material of the component B was increased; and when the content of the ions in the flowing water (C(_{SO4}²⁻) was ≤0.8 g/L and C(Cl⁻) was ≤5.3 g/L) was low, the size of the karst cavity was smaller than 0.5 m*0.5 m*0.5 m, and the flow velocity of the flowing water was smaller than 0.5 mls, the water-to-cementing material ratio in the component A was selected to be 1.0 and the mixing amount of auxiliary materials of the component B was decreased;
S2: preparing the components A and B into the slurries A and B according to the respective proportions for later use; and
S3: grouting was performed using the slurries A and B at the volume ratio 3:1 by the means of two-slurry grouting (real object of the grouting material was shown in FIG. 3).

After testing, the coastal karst cement-based expanding grouting material has good stability under the condition of flowing water. Under the velocity of the flowing water of 1.2 m/s, the retention of the slurry after initial solidification is 82-98% and therefore plugging of the flowing water at high flow velocity can be realized.

### Example 2

A coastal karst cement-based expanding grouting material was provided. The expanding grouting material was composed of components A and B; the component A comprised 42.5 silicate cement, water and an expanding agent of 0.01%, and the water-to-cementing material ratio was 0.5:1; and the component B comprised the following components in weight percentages: 1.3% of guar gum, 0.5% of polyacrylamide, 2.0% of calcium polyacrylate, 1.5% of sodium hexametaphosphate, 0.05% of polyethylene glycol-2000, 70% of sodium silicate and 24.65% of water.

The expanding agent was prepared into a solution and from the following components in mass percentages: 0.04% of a polyacrylate derivative, 0.04% of sodium dodecyl sulfonate, 0.02% of sodium dodecyl sulfate, 0.025% of aluminum dodecyl sulfate, 1.2% of α-alkenyl sodium sulfonate and 0.4% of aluminum powder.

A method for preparing the coastal karst cement-based cementing expanding material comprised:
(1) preparation of component A: the cementing material was mixed with the water to prepare a slurry and an expanding agent solution was prepared for later use; and
(2) preparation of component B: in weight percentages, the water-soluble vegetable gum, the polyacrylamide and an acrylic acid derivative salt thereof, the complexing agent and the polyhydroxy polysaccharides were dissolved in the water, and then the water glass was added to prepare a slurry B for later use.

### Example 3

A coastal karst cement-based expanding grouting material was provided. The expanding grouting material was composed of components A and B; the component A comprised 42.5 silicate cement, water and an expanding agent of 6.0%, and the water-to-cementing material ratio was 0.6:1; and the component B comprised the following components in weight percentages: 1.0% of guar gum, 1.0% of polyacrylamide, 1.0% of calcium polyacrylate, 1.5% of sodium hexametaphosphate, 0.8% of polyethylene glycol-2000, 50% of sodium silicate and 44.7% of water.

The expanding agent was prepared into a solution and from the following components in mass percentages: 0.04% of a polyacrylate derivative, 0.04% of sodium dodecyl sulfonate, 0.02% of sodium dodecyl sulfate, 0.025% of aluminum dodecyl sulfate, 1.2% of α-alkenyl sodium sulfonate and 0.4% of aluminum powder.

A method for preparing the coastal karst cement-based cementing expanding material comprised:
(1) preparation of component A: the cementing material was mixed with the water to prepare a slurry and an expanding agent solution was prepared for later use; and
(2) preparation of component B: in weight percentages, the water-soluble vegetable gum, the polyacrylamide and an acrylic acid derivative salt thereof, the complexing agent and the polyhydroxy polysaccharides were dissolved in the water, and then the water glass was added to prepare a slurry B for later use.

### Example 4

A coastal karst cement-based expanding grouting material was provided. The expanding grouting material was composed of components A and B; the component A comprised 42.5 silicate cement, water and an expanding agent of 6.0%, and the water-to-cementing material ratio was 0.6:1; and the component B comprised the following components in weight percentages: 1.0% of guar gum, 1.0% of polyacrylamide, 1.0% of calcium polyacrylate, 1.5% of sodium hexametaphosphate, 0.8% of polyethylene glycol-2000, 50% of sodium silicate and 44.7% of water.

The expanding agent was prepared into a solution and from the following components in mass percentages: 0.01% of a polyacrylate derivative, 0.02% of sodium dodecyl sulfonate, 0.03% of sodium dodecyl sulfate, 0.02% of aluminum dodecyl sulfate and 0.05% of α-alkenyl sodium sulfonate.

A method for preparing the coastal karst cement-based cementing expanding material comprised:
(1) preparation of component A: the cementing material was mixed with the water to prepare a slurry and an expanding agent solution was prepared for later use; and
(2) preparation of component B: in weight percentages, the water-soluble vegetable gum, the polyacrylamide and an acrylic acid derivative salt thereof, the complexing agent and the polyhydroxy polysaccharides were dissolved in the water, and then the water glass was added to prepare a slurry B for later use.

According to the national standard GB/T17671-1999, the method of testing cements-determination of strength, the materials obtained in the examples were tested. The test results showed that the 1-d compressive strength of the concretion body was 0.2-1.5 MPa and the 3-d compressive strength was 0.5-4.0 MPa.

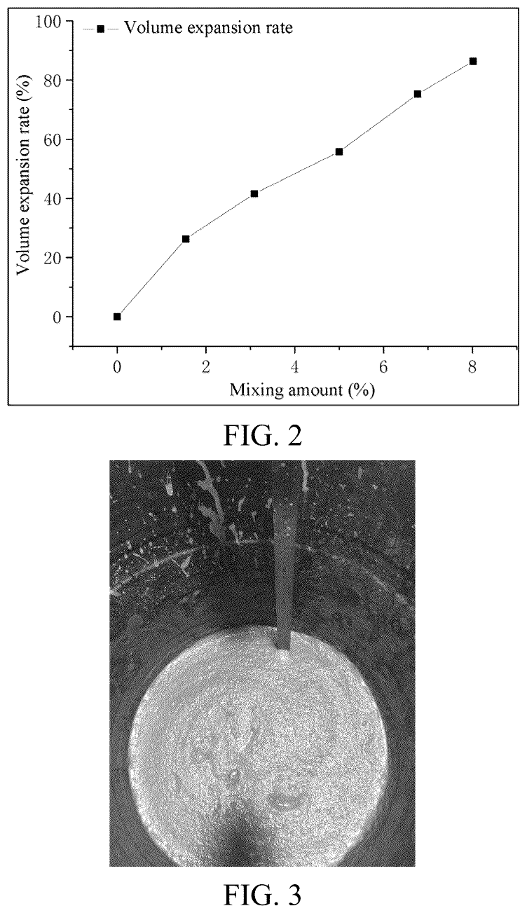

FIG. 2 was a dynamic relationship diagram of the mixing amount in mass proportion and the volume expansion rate of the cement according to the present invention. It can be seen from FIG. 2 that the volume expansion rate increased with the increase of the mixing amount in mass proportion of the coastal karst cementing-based cementing expanding material.

The foregoing descriptions are merely preferred examples of the present application, and are not intended to limit the present application. For a person skilled in the art, various modifications and changes may be made to the present application. Any modifications, equivalent replacements, improvements, and the like made within the spirit and principle of the present application shall fall within the protection scope of the present application.

1. A coastal karst cement-based expanding grouting material, wherein the expanding grouting material is composed of components A and B; the component A comprises a cementing material with volcanic ash characteristics, water and an expanding agent of 0.01-6.0%; the component B comprises the following components in weight percentages: 0.2-1.3% of a water-soluble vegetable gum, 0.5-2.0% of polyacrylamide, 0.01-2.0% of a polyacrylic acid derivative salt, 0.02-1.5% of a complexing agent, 0.05-1.5% of polyhydroxy polysaccharides, 2-70% of water glass and 42.3-90.3% of water;
the expanding agent is prepared into a solution and from the following components in mass percentages: 0.01-0.05% of a polyacrylate derivative, 0.02-0.05% of sodium dodecyl sulfonate, 0.02-0.05% of sodium dodecyl sulfate, 0.02-0.05% of aluminum dodecyl sulfate, 0.03-1.5% of α-alkenyl sodium sulfonate and 0-0.6% of aluminum powder;
the complexing agent comprises one or more of polyaluminium chloride, polyferric chloride, polyaluminium silicate, polyferric silicate, sodium citrate and sodium hexametaphosphate;
the volume ratio of the component A to the component B is (0.5-5):1;
when the content of ions in flowing water C(SO₄²⁻) is ≥0.8 g/L and C(Cl⁻) is ≥5.3 g/L, the size of a karst cavity is greater than 1 m*1 m*1 m, and the flow velocity of the flowing water is greater than 0.5 mls, the water-to-cementing material ratio in the component A is lower than 0.9 and the mixing amount of each auxiliary material of the component B is increased; and when the content of the ions in the flowing water C(SO₄²⁻) is ≤0.8 g/L and C(Cl⁻) is ≤5.3 g/L, the size of the karst cavity is smaller than 0.5 m*0.5 m*0.5 m, and the flow velocity of the flowing water is smaller than 0.5 mls, the water-to-cementing material ratio in the component A is selected to be 1.0 and the mixing amount of each auxiliary material of the component B is decreased; and
the polyhydroxy polysaccharides comprises one or two of polyethylene glycol-2000, sodium gluconate, sodium alginate and curdlan.

2. The coastal karst cement-based expanding grouting material according to claim 1, wherein the cementing material with volcanic ash characteristics is selected from one or more of silicate cement, granulated blast furnace slag, fly ash, kiln dust and silica fume.

3. The coastal karst cement-based expanding grouting material according to claim 2, wherein the granulated blast furnace slag is selected and the mixing amount thereof is 2-20% by mass of a cement-based solid material.

4. The coastal karst cement-based expanding grouting material according to claim 3, wherein the mixing amount is 5-15% by mass of the cement-based solid material.

5. The coastal karst cement-based expanding grouting material according to claim 2, wherein the silicate cement comprises one or more of 42.5, 42.5R, 52.5 and 52.5R common silicate cement.

6. The coastal karst cement-based expanding grouting material according to claim 1, wherein
the expanding agent is prepared into a solution and from the following components in mass percentages: 0.01-0.04% of a polyacrylate derivative, 0.02-0.04% of sodium dodecyl sulfonate, 0.02-0.03% of sodium dodecyl sulfate, 0.02-0.025% of aluminum dodecyl sulfate, 0.05-1.2% of α-alkenyl sodium sulfonate and 0-0.4% of aluminum powder.

7. The coastal karst cement-based expanding grouting material according to claim 1, wherein the water-soluble vegetable gum comprises one or more of guar gum, pectin, locust bean gum, carrageenan and carob bean gum;
the polyacrylic acid derivative salt comprises one or more of sodium polyacrylate and calcium polyacrylate; and
the water glass comprises one or more of sodium silicate, potassium silicate and sodium aluminate.

8. The coastal karst cement-based expanding grouting material according to claim 1, wherein the component B comprises the following components in percentages: 0.5-1.3% of the water-soluble vegetable gum, 0.5-2.0% of the polyacrylamide, 0.01-2.0% of the polyacrylic acid derivative salt, 0.02-0.3% of the complexing agent, 0.05-1.2% of the polyhydroxy polysaccharides, 2-35% of the water glass and 55.3-90.3% of the water.

9. The coastal karst cement-based expanding grouting material according to claim 1, wherein the volume ratio of the component A to the component B is (1-4):1.

10. The coastal karst cement-based expanding grouting material according to claim 9, wherein the volume ratio of the component A to the component B is (1-3):1.

11. The coastal karst cement-based expanding grouting material according to claim 10, wherein the volume ratio of the component A to the component B is 3:1.

12. The coastal karst cement-based expanding grouting material according to claim 1, wherein the component A further comprises an early strength agent or a water reducing agent;
the early strength agent accounts for 0.3-3.5% of the total mass of the cementing material in the component A;
the early strength agent comprises one or two of lithium chloride and sodium chlorate;
the water reducing agent accounts for 0.4-2.4% of the total mass of the cementing material in the component A; and
the water reducing agent comprises a lignosulfonate water reducing agent or a polycarboxylic acid water reducing agent.

13. A method for preparing the coastal karst cement-based expanding grouting material according to claim 1, comprising:
(1) preparation of component A: mixing a cementing material with volcanic ash characteristics with water to prepare a slurry, preparing an expanding agent solution, and adding the same into the slurry to prepare a slurry A; and
(2) preparation of component B: in weight percentages, dissolving a water-soluble vegetable gum, polyacrylamide, a polyacrylic acid derivative salt, a complexing agent and polyhydroxy polysaccharides in the water, and then adding water glass to prepare a slurry B for later use.

14. A method for filling and plugging coastal karst flowing water using the coastal karst cement-based expanding grouting material according to claim 13, comprising:
S1: determining the respective proportions of the components A and B according to the content of ions in the flowing water, the size of the conduit karst cavity, the flow velocity of the flowing water, the water pressure and the distance between a drill hole and a flowing water channel;
S2: preparing components A and B into the slurries A and B according to the respective proportions for later use; and
S3: performing grouting using the slurries A and B at the volume ratio of (0.5-5):1 by the means of two-slurry grouting.

15. The method for filling and plugging coastal karst flowing water using the coastal karst cement-based expanding grouting material according to claim 14, wherein in step S3, the volume ratio of the slurry A to the slurry B is (1-4):1.

16. The method for filling and plugging coastal karst flowing water using the coastal karst cement-based expanding grouting material according to claim 15, wherein in step S3, the volume ratio of the slurry A to the slurry B is (1-3):1.

17. The method for filling and plugging coastal karst flowing water using the coastal karst cement-based expanding grouting material according to claim 16, wherein in step S3, the volume ratio of the slurry A to the slurry B is 3:1.

18. Use of the coastal karst cement-based expanding grouting material according to claim 1 in the fields of high-speed railways, expressways, urban railway system, large-scale hydraulic and hydroelectric engineering and deep mine construction.
